(19) United States
(12) Patent Application Publication
(10) Pub. No.: US 2010/0183948 A1
(43) Pub. Date: Jul. 22, 2010

(54) Closed-end nanotube arrays as an electrolyte of a solid oxide fuel cell

(76) Inventors: Cheng-Chieh Chao, Stanford, CA (US); Turgut M. Gür, Palo Alto, CA (US); Munekazu Motoyama, Kumamoto (JP); Friedrich B. Prinz, Woodside, CA (US); Joon Hyung Shim, Cupertino, CA (US); Joong Sun Park, Stanford, CA (US)

Correspondence Address: LUMEN PATENT FIRM, 350 Cambridge Avenue, Suite 100, PALO ALTO, CA, 94306, US

(21) Appl. No.: 12/653,111

(22) Filed: Dec. 7, 2009

Related U.S. Application Data
(60) Provisional application No. 61/200,954, filed on Dec. 5, 2008.

(51) Int. Cl. H01M 8/10

(52) U.S. Cl. 429/495

(57) ABSTRACT

The present invention provides solid oxide fuel cell that includes an electrolyte membrane, a first electrode layer, and a second electrode layer, where the electrolyte membrane is disposed between the first electrode layer and the second electrode layer. The electrolyte membrane includes a solid electrolyte structure having at least two solid electrolyte nanoscopic closed-end tubes, where an open-ended base of each solid electrolyte nanoscopic closed-end tube is connected by a solid electrolyte layer.

### CROSS-REFERENCE TO RELATED APPLICATIONS

This application is cross-referenced to and claims the benefit from U.S. Provisional Application 61/200,954 filed Dec. 5, 2008, and which are hereby incorporated by reference.

### FIELD OF THE INVENTION

The present invention relates generally to fuel cell devices. More particularly, the invention relates to a method of fabricating arrays of ion-conductive solid oxide nanotubes with closed ends as an electrolyte membrane of a solid oxide fuel cell (SOFC). A ten to thirty-fold increase in the surface area is achieved, depending on the length and diameter of nanowires. The ohmic loss and the mass transfer resistances of chemical species are suppressed because of the ordered orientation of the nanowires.

### BACKGROUND

Solid oxide fuel cells (SOFCs) are one type of fuel cell. SOFCs operate at a relatively high temperature (700-1000° C.), thereby having a higher energy conversion efficiency than other types of fuel cells. A complicated cooling system is not required. Solid oxide materials capable of conducting oxygen ions, such as yttria stabilized zirconia (YSZ), are used as the electrolyte in SOFCs.

SOFCs which can produce high efficiencies in the temperature range of 650-750° C. are desirable for improved stability and cost reduction. Decreasing the ohmic loss and the activation loss as well as enhancing gas transport into the triple phase boundaries (TPBs) are critical to improving the electrode performance.

To operate a SOFC, sufficient O₂ gas and H₂ gas must be delivered to the anode and the cathode is kept separate by an electrolyte membrane, respectively. Oxygen atoms adsorbed on the cathode catalyst surface obtain electrons at the TPB to become O²⁻ ions [O₂(g)+4e⁻→2O²⁻]. Those O²⁻ ions transfer through the electrolyte membrane to the anode where they combine with H₂ gas molecules resulting in water [H₂(g)+2O²⁻→H₂O(g)+4e⁻] at the TPB on the anode side. The electrons are passed from the anode to the cathode via an external circuit.

Accordingly, there is a need to develop a structure and method for reducing the activation loss and to increase the total TPB area. There is a further need to enlarge the surface area supporting the catalyst electrode in the electrolyte membrane with minimal increase in the volume.

### SUMMARY OF THE INVENTION

The present invention provides solid oxide fuel cell that includes an electrolyte membrane, a first electrode layer, and a second electrode layer, where the electrolyte membrane is disposed between the first electrode layer and the second electrode layer. The electrolyte membrane includes a solid electrolyte structure having at least two solid electrolyte nanoscopic closed-end tubes, where an open-ended base of each solid electrolyte nanoscopic closed-end tube is connected by a solid electrolyte layer.

According to one aspect of the current invention, the structured solid electrolyte can be a material that can include yttria stabilized zirconia (YSZ) or YSZ-Ni.

In a further aspect of the invention, the structured solid electrolyte has a thickness in a range of 10 nm to 100 nm.

According to another aspect, the at least two nanoscopic closed-end tubes have an array density in a range of 1 cm⁻² to 10⁹ cm⁻².

In another aspect of the invention the at least two nanoscopic closed-end tubes have a length in a range of 1 μm to 50 μm.

In yet a further aspect, the at least two nanoscopic closed-end tubes have a diameter in a range of 10 nm to 100 nm.

According to another aspect of the invention, a first electrode layer is disposed on an outer surface of the structure and a second electrode layer is disposed on an inner surface of the structure.

In a further aspect of the invention, each electrode layer has a thickness in a range of 10 nm to 100 nm.

According to one aspect, the solid electrolyte structure comprises a multi-shell YSZ-Ni nanotube.

### BRIEF DESCRIPTION OF THE FIGURES

The objectives and advantages of the present invention will be understood by reading the following detailed description in conjunction with the drawing, in which:

FIG. 1 shows a cross section view of a closed-end nanotube membrane electrode assembly according to the present invention.

FIGS. 2(a)-2(f) show the steps of fabricating a closed-end nanotube membrane electrode assembly according to the present invention.

FIG. 3 shows a scanning electron microscope image of the closed-end solid oxide nanotubes after leaching Ni nanowires using 10 vol. % nitric acid according to the present invention.

FIGS. 4(a)-4(d) show exemplary SEM images of Ni nanowires and of the Ni nanowires coated with YSZ, in addition to their associated diameters, according to the current invention.

FIGS. 5(a)-5(d) show a multishell YSZ-Ni nanotube array structure according to the current invention.

FIGS. 6(a)-6(d) show SEM images of the multishell YSZ-Ni nanotube arrays coated with an outer electrode layer, such as a Pt. layer according to the current invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention provides solid oxide nanowire arrays for SOFC applications, where arrays of solid oxide nanowires are used to increase the area available for supporting the catalyst, and thus increasing total TPB area. The nanowire structure has an additional lateral surface compared to a flat solid oxide electrolyte, and the nanowires can be arrayed densely (1-10⁹ cm⁻²). Thus, the actual surface area can be increased to more than one hundred times as large as a plane area. Moreover, the nanowires are aligned vertically on the substrate; parallel to the current flow direction as well as the gas diffusion direction. The orientation of nanowires reduces the ohmic loss and the gas transfer resistances, as compared with random-porous media such as cermet electrodes.

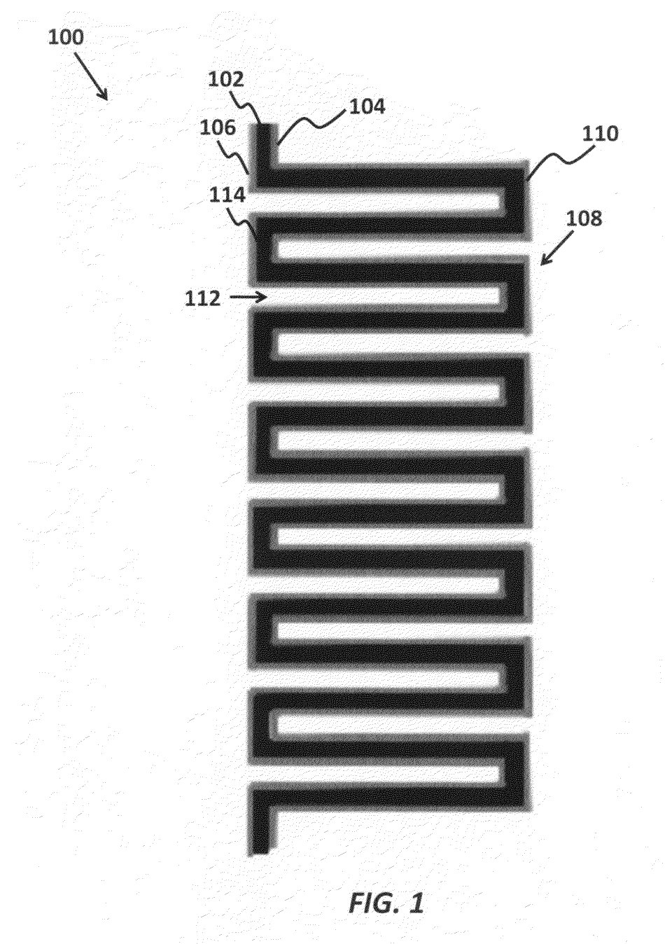

According to one embodiment, FIG. 1 shows a cross section view of a closed-end nanotube membrane electrode assembly 100 (MEA) according to the present invention. The MEA 100 includes an electrolyte membrane 102, a first electrode layer 104, and a second electrode layer 106, where the electrolyte membrane 102 is disposed between the first electrode layer 104 and the second electrode layer 106. The electrolyte membrane 102 includes a solid electrolyte structure 108 having at least two solid electrolyte nanoscopic closed-end tubes 110, where an open-ended base 112 of each solid electrolyte nanoscopic closed-end tube 110 is connected by a solid electrolyte layer 114. The structured solid electrolyte can be a material that can include yttria stabilized zirconia (YSZ), YSZ-Ni, or any other suitable electrolyte material.

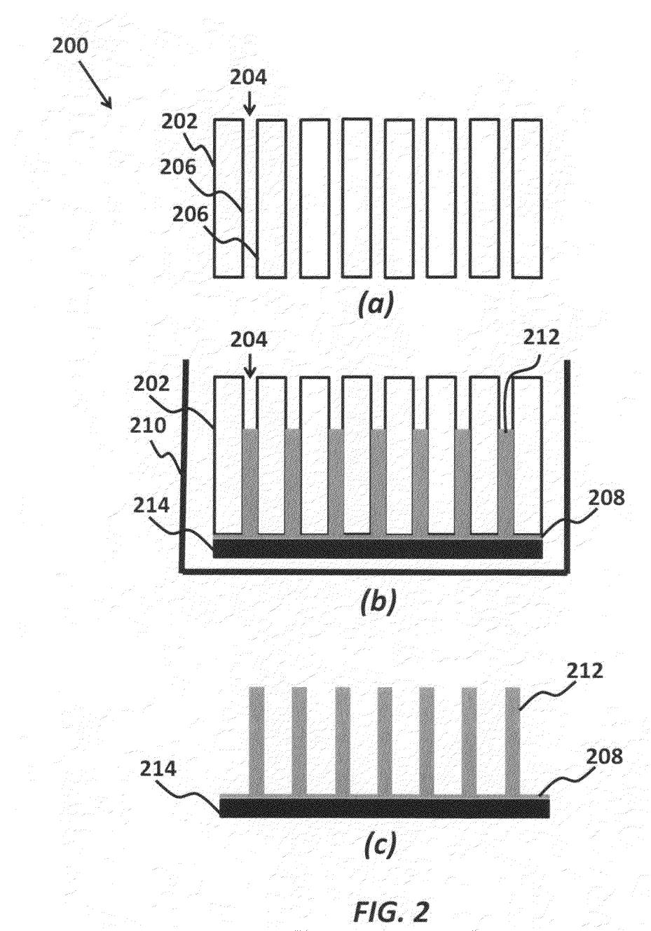

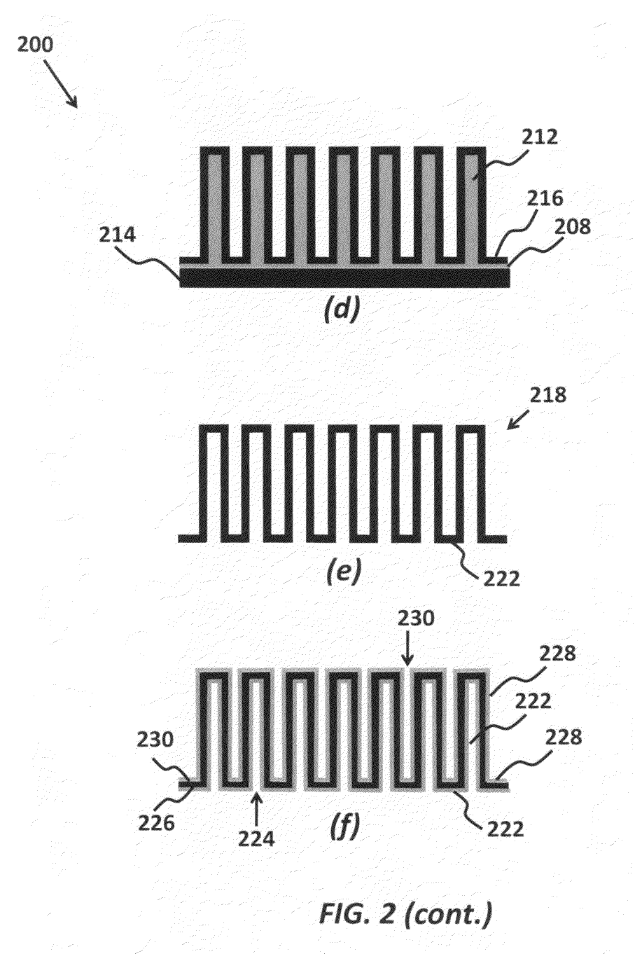

FIGS. 2(a)-2(f) show the steps 200 fabricating a closed-end nanotube MEA 100 according to the present invention. FIG. 2(a) shows the step of providing a growth template 202, where the growth template 202 has nanoscopic pores 204 disposed in chemically stable and insulating walls 206. In one aspect, the required properties for the template 202 are a high number density of nanoscopic pores and chemically stable insulating walls. A porous anodic alumina film can be also used. In another aspect, porous anodic alumina can be used as the template for growing the nanowires. Any metal that may be electrodeposited, can be selected as a nanowire material.

FIG. 2(b) shows the step of depositing a conductive layer 208 on a surface of the growth template 202, where a portion of the conductive layer 208 is further deposited in the nanoscopic pores 204, and the growth template 202 and the conductive surface 208 are then immersed in an electroplating bath 210 having metal ions. In another aspect, one face of the template 202 is coated with a sputter-deposited conductive layer. A PtPd alloy is deposited. This thin layer serves as the cathode for electroplating. Any material more noble than the desired nanowire material can be used as the cathode for electroplating. An electric potential is applied to the conductive surface 208, where nanaowires 212 grow along the nanoscopic pores 204 the potential applied to the cathode layer, where the nanaowire growth is stopped before the nanowire 212 reaches an end of the nanoscopic pore 204. In one embodiment, Ni nanowires were electroplated.

The conductive surface 208 having the nanaowires 212 is then attached to a thicker and more mechanically stable substrate 214. where the two parts are connected by electroplating a metal on the substrate backside. In a further aspect, the solid oxide layer has a uniform thickness covering the entire surface of the metal nanowire array and can be deposited by atomic layer deposition (ALD). As an example, YSZ deposition is conducted by the ALD method. The optimum range of the YSZ layer thickness is 10 to 10² nm. The bottom surface of the whole structure is also covered with YSZ as a result of the ALD process. Ar-sputter etching or focused-ion-beam (FIB) etching can be performed to remove the YSZ layer on the bottom.

FIG. 2(c) shows the step of removing the growth template 202, where the conductive surface 208 and the nanowires 212 are exposed on the substrate 214. The metallic nanowires can be removed in a strong acid solution. This process creates hollow YSZ nanotubes with closed tips. The solid oxide nanowire arrays have additional area along their lateral surfaces when compared to planar YSZ. A more than one-hundred-fold increase in the surface area is achieved, depending on the length (1-50 μm) and diameter (10-10² nm) of nanowires. This enhancement corresponds to an increase of the TPB area by the same magnitude. The TPB is an energy conversion reaction site for the SOFC, and hence a higher rate of energy conversion per unit of geometric area through the overall cell circuit can be expected. The nanowires are aligned toward the anode. The pathways to the anode of the O²⁻ ions generated at the cathode are very straight and short, in contrast with cermet electrodes. Shorter diffusion pathways reduce the ohmic loss. Additionally, gas phase space between the nanowires is also straight and open, and the flows through the lateral networks result in a lower gas transfer resistance.

FIG. 2(d) shows the step of depositing a solid oxide layer 216 on the exposed nanaowires 212 and on the exposed conductive surface 208, where the solid oxide layer 216 is a substantially uniform-thickness. The very thin solid oxide electrolyte layer is uniformly deposited on the entire surface of the nanowire arrays by the ALD method. The ohmic loss in the electrolyte membrane is thus extremely suppressed.

FIG. 2(e) shows the step of removing the nanowires 212, the conductive surface 208 and the substrate 214, where closed-end tubes 218 of the solid oxide layer 212 are exposed. The closed-end solid oxide nanotubes 218 are connected by a connective solid oxide surface 220 there between. FIG. 2(e) shows the step of depositing a first electrode layer 222 on an inner surface 224 of the closed-end solid oxide nanotubes 218 and on a bottom surface 226 of the connective solid oxide surface 220, and depositing a second electrode layer 228 on a top surface 230 of the closed-end solid oxide nanaotubes 218 and on a top surface of the connective solid oxide surface 220.

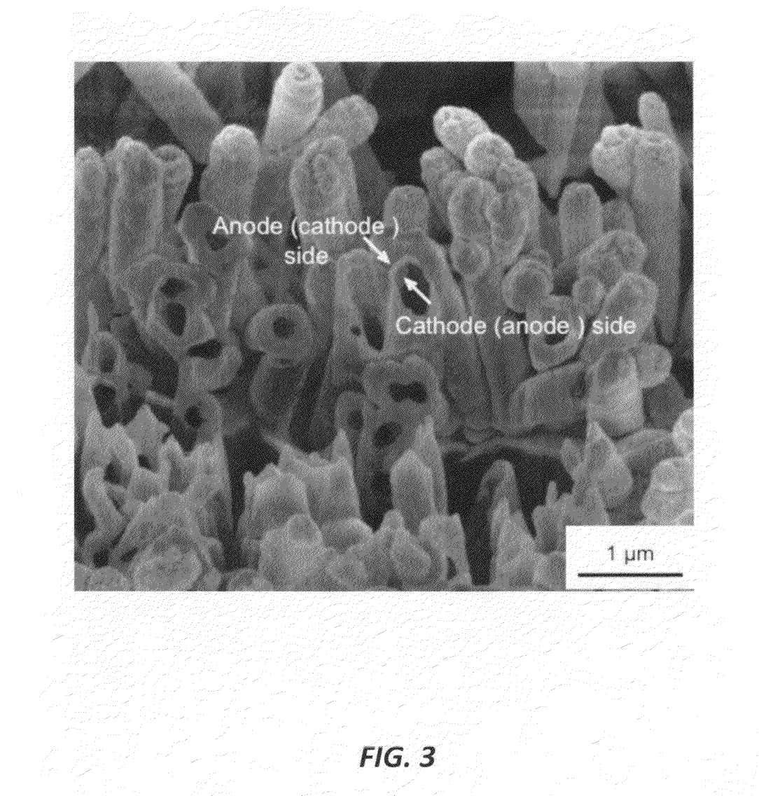

FIG. 3 shows a scanning electron microscope image of the closed-end solid oxide nanotubes after leaching Ni nanowires using 10 vol. % nitric acid, where a first electrode layer [Anode (cathode)] is disposed on the exterior of the closed-end solid oxide nanotube and a second electrode layer [Cathode (anode)] is disposed on the inside of the closed-end solid oxide nanotubes.

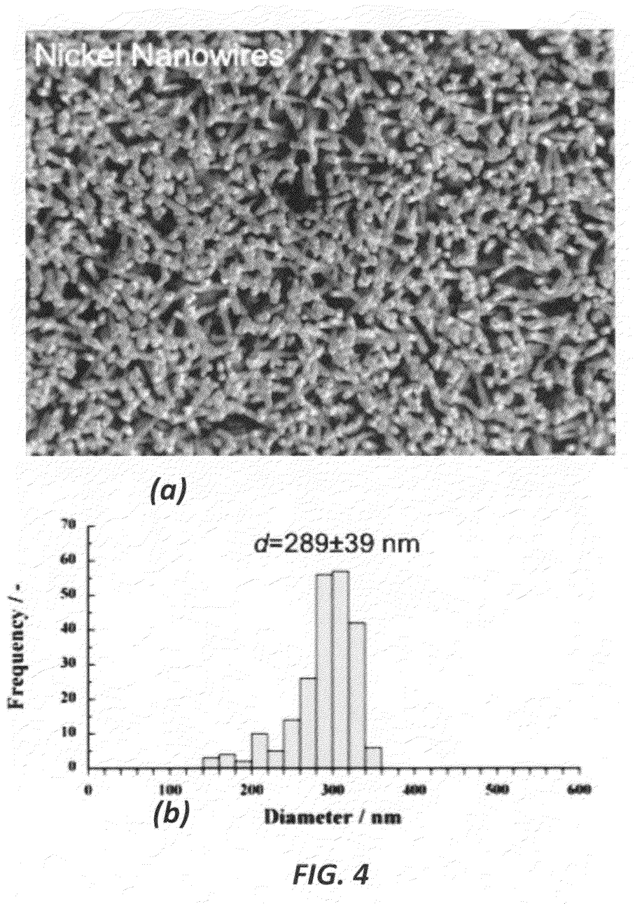

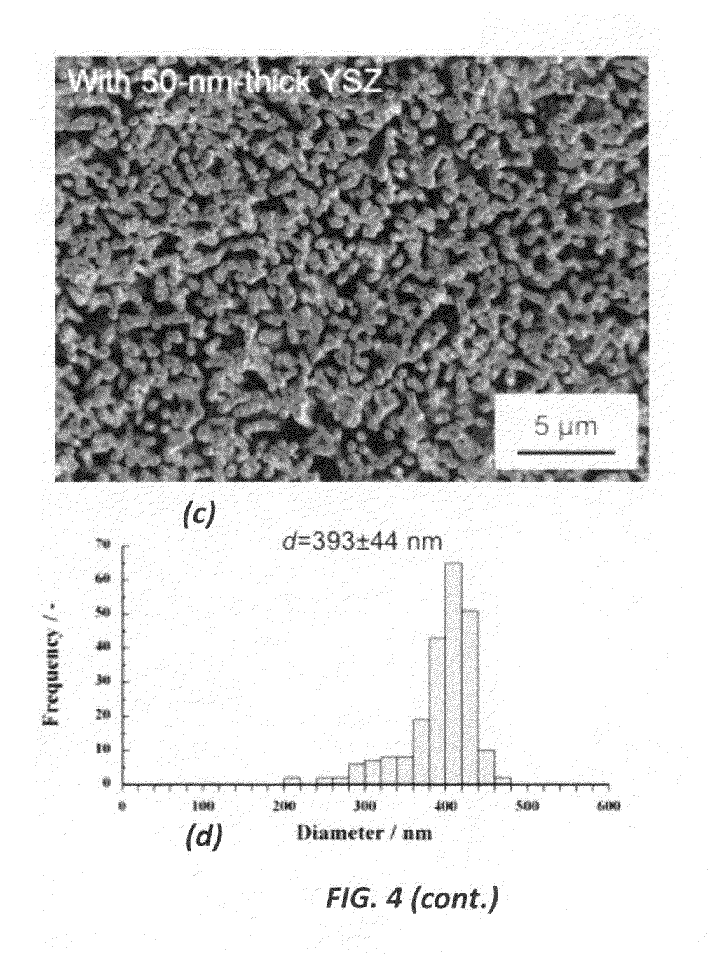

FIGS. 4(a)-4(d) show exemplary SEM images of Ni nanowires and of the Ni nanowires coated with YSZ, in addition to their associated diameters, according to the current invention. As shown in FIG. 4(b), the Ni nanaowires have a mean diameter of about 289 nm, and as shown in FIG. 4(d), the YSZ coated on the Ni nanowires have a mean diameter of about 393 nm.

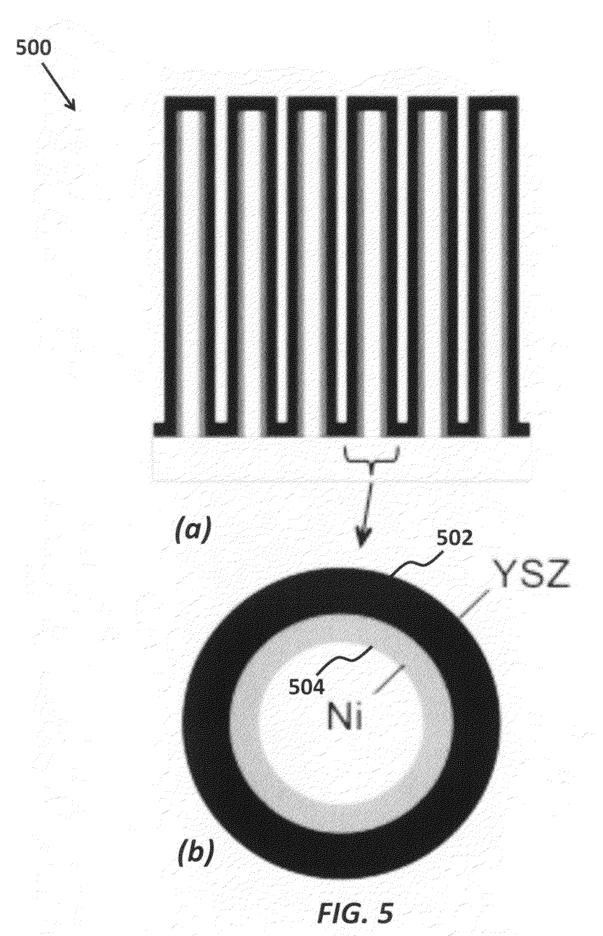

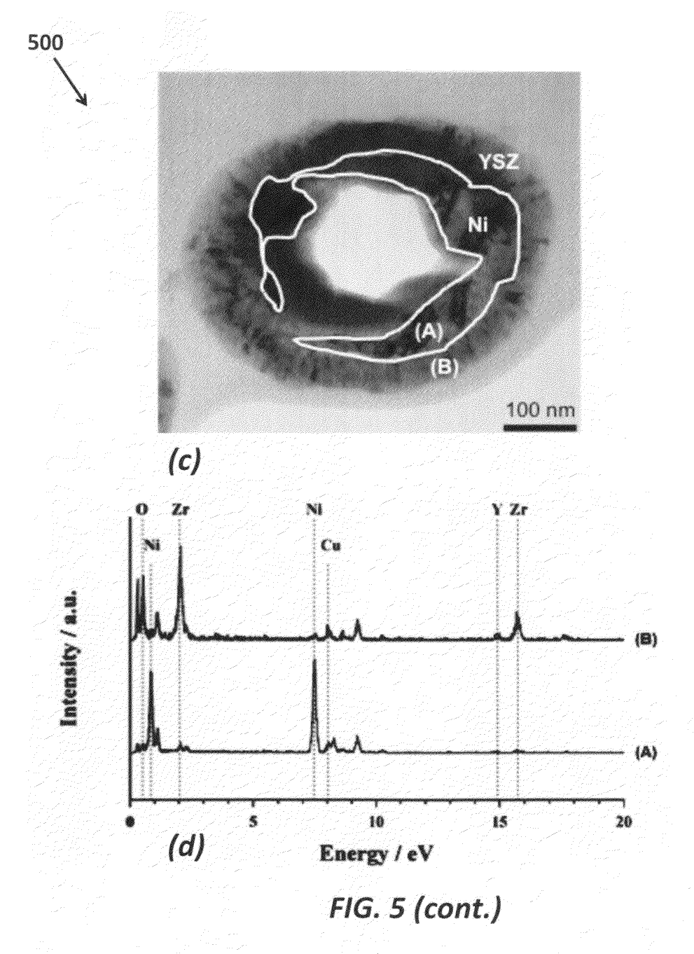

Another aspect of the current invention includes multishell YSZ-Ni nanotube arrays. FIGS. 5(a)-5(d) show a multishell YSZ-Ni nanotube array structure 500 according to the current invention, where shown is a YSZ nanotube shell 502 that is coated with Ni inner sleeves 504. FIG. 5(c) shows an SEM image of the YSZ-Ni nanotube array structure 500.

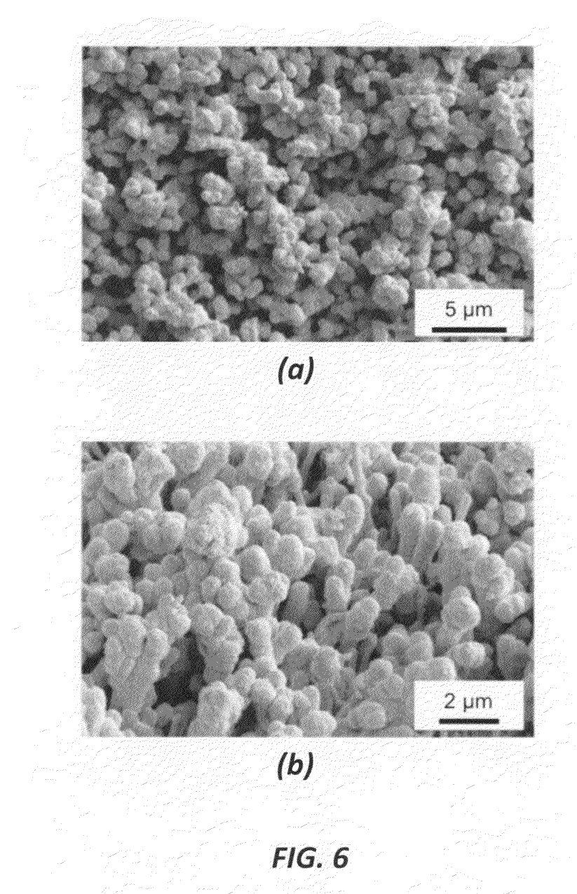

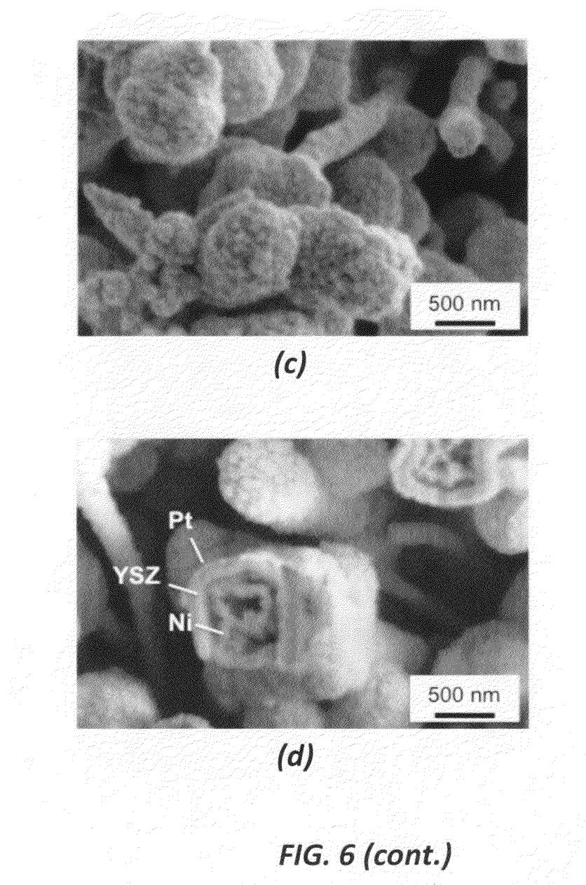

FIGS. 6(a)-6(d) show SEM images of the multishell YSZ-Ni nanotube arrays coated with an outer electrode layer, such as a Pt. layer.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed is:

1. A solid oxide fuel cell comprising:
a. an electrolyte membrane;
b. a first electrode layer; and
c. a second electrode layer, wherein said electrolyte membrane is disposed between said first electrode layer and said second electrode layer, wherein said electrolyte membrane comprises a solid electrolyte structure comprising at least two solid electrolyte nanoscopic closed-end tubes, wherein an open-ended base of each said solid electrolyte nanoscopic closed-end tube is connected by a solid electrolyte layer.

2. The solid oxide fuel cell of claim 1, wherein said structured solid electrolyte comprises a material selected from the group consisting of yttria stabilized zirconia (YSZ), and YSZ-Ni.

3. The solid oxide fuel cell of claim 1, wherein said structured solid electrolyte has a thickness in a rang of 10 nm to 100 nm.

4. The solid oxide fuel cell of claim 1, wherein said at least two nanoscopic closed-end tubes have an array density in a range of 1 cm⁻² to 10⁹ cm⁻².

5. The solid oxide fuel cell of claim 1, wherein said at least two nanoscopic closed-end tubes have a length in a range of 1 μm to 50 μm.

6. The solid oxide fuel cell of claim 1, wherein said at least two nanoscopic closed-end tubes have a diameter in a range of 10 nm to 100 nm.

7. The solid oxide fuel cell of claim 1, wherein said first electrode layer is disposed on an outer surface of said structure and a second electrode layer is disposed on an inner surface of said structure.

8. The solid oxide fuel cell of claim 1, wherein each said electrode layer has a thickness in a range of 10 nm to 100 nm.

9. The solid oxide fuel cell of claim 1, wherein each said solid electrolyte structure comprises a multi-shell YSZ-Ni nanotube.
